(19) United States
(12) Patent Application Publication
(10) Pub. No.: US 2026/0270096 A1
(43) Pub. Date: Sep. 10, 2026

(54) Multi-Layer Dynamic Encryption System Integrating Contextual and AI-Driven Encoding for Post-Quantum Security

(71) Applicant: DARREN KANE, DUBLIN (IE)

(72) Inventor: DARREN KANE, DUBLIN (IE)

(21) Appl. No.: 19/182,812

(22) Filed: Apr. 18, 2025

Related U.S. Application Data
(63) Continuation-in-part of application No. 19/075,640, filed on Mar. 10, 2025.

(51) Int. Cl. H04L 9/32; G06F 21/60

(52) U.S. Cl. CPC H04L 9/3271; G06F 21/602

(57) ABSTRACT

This Continuation-in-Part discloses an extension to a structured, non-key-based encryption model through the integration of two secure processing layers: a contextual transformation module and an adaptive challenge-response engine. The invention ensures data obfuscation, dynamic encryption logic, and resistance to modern and future attack models. All layers operate within isolated execution environments, and no transformation rules or semantic mappings are exposed or stored externally.

### CROSS-REFERENCE TO RELATED APPLICATIONS

This application is a Continuation-in-Part of U.S. patent application Ser. No. [19/075,640], filed on Mar. 10, 2025, titled:
“Advanced Cryptographic Encoding System for Secure Digital Communication and Data Protection.”

### STATEMENT REGARDING FEDERALLY SPONSORED RESEARCH OR DEVELOPMENT

Not applicable. No federal funding was used in the development of this invention.

### FIELD OF THE INVENTION

The invention relates to the field of digital security, particularly to advanced, multi-layered encryption systems that resist decryption by quantum computing, artificial intelligence, and brute-force attacks. This CIP introduces two additional transformation layers to the previously disclosed structured, non-key-based encryption method.

### BACKGROUND OF THE INVENTION

Traditional encryption models (e.g., RSA, AES, ECC) rely on fixed key structures and deterministic algorithms, making them vulnerable to emerging threats, including:
Quantum computing decryption (e.g., Shor's algorithm)
AI pattern recognition and adversarial decryption models
Static key management flaws and predictability risks

The parent application disclosed a keyless transformation model. This Continuation-in-Part introduces two additional logical layers that enhance obfuscation and unpredictability by applying abstract contextual transformations and one-time challenge generation.

These enhancements:
Do not rely on numeric key complexity
Avoid reuse of encryption states
Generate outputs that resist reverse-engineering and logical prediction

### SUMMARY OF THE INVENTIONS

This invention builds upon the parent application by introducing:

### Layer 2: Contextual Obfuscation Layer

Applies abstract contextual reshaping to secured data
Transforms digital input into non-identifiable, non-symbolic text structures
Format is designed to resemble ordinary communication while embedding secure transformations
Operates through private configuration rules, not visible externally

### Layer 3: One-Time Adaptive Challenge Layer

Generates dynamic, session-specific challenges upon data access
Each challenge is context-aware and non-repeating
Response must match the originating configuration model
Adds a behavioral and logic-based verification process

Together, these layers augment the parent Layer 1 transformation to produce a multi-tiered security architecture that is:
Keyless
Obfuscated
Adaptive
Resistant to both classical and next-generation attack models

### BRIEF DESCRIPTION OF THE DRAWINGS

FIG. 1: System Overview Architecture

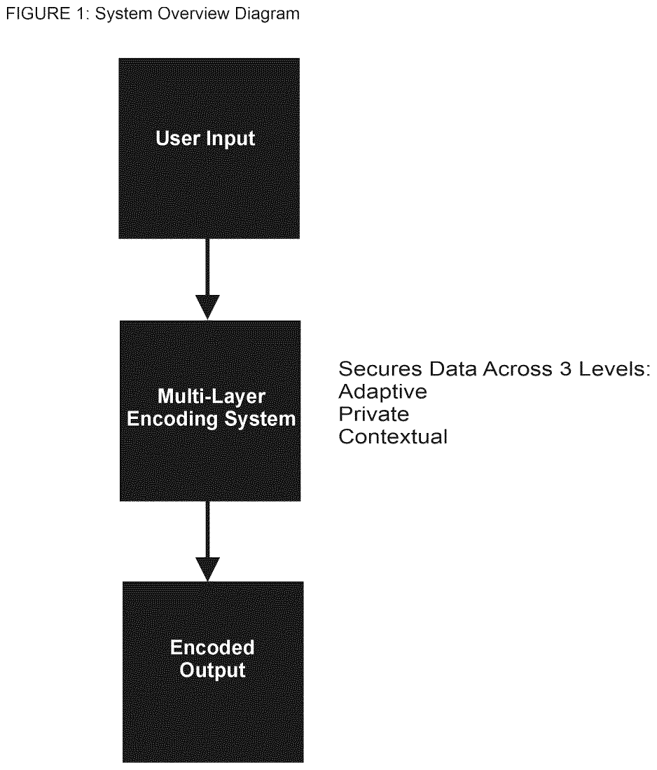

FIG. 2: Data Flow: Input→Multi-Layer Encoding Process

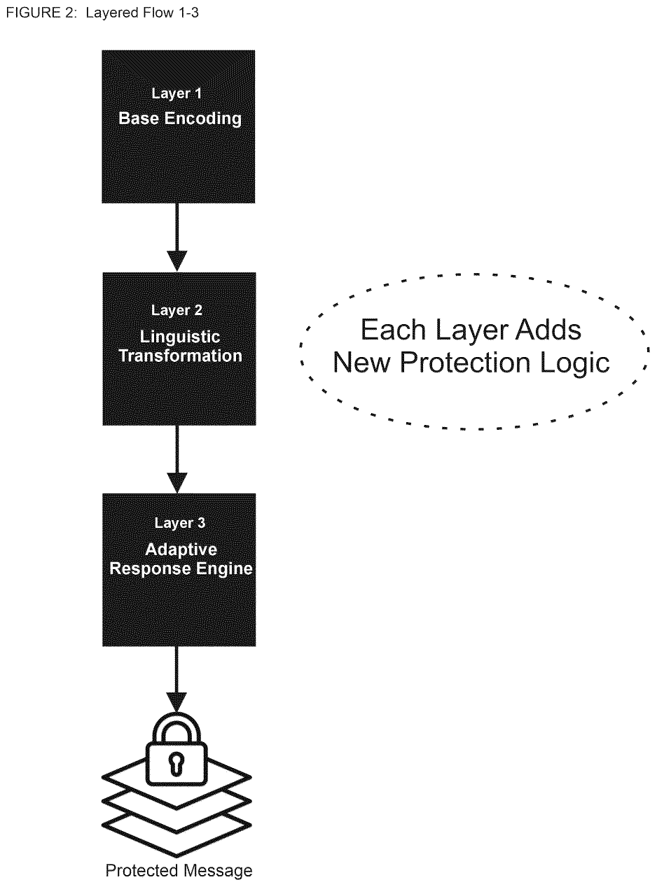

FIG. 3: Contextual Reshaping Model in Layer 2

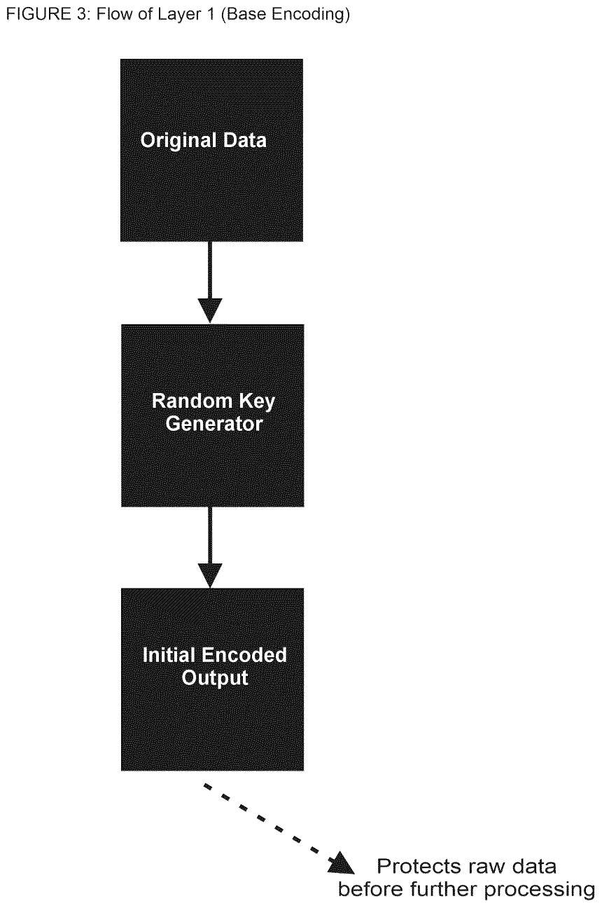

FIG. 4: Dynamic Challenge Mechanism Flow in Layer 3

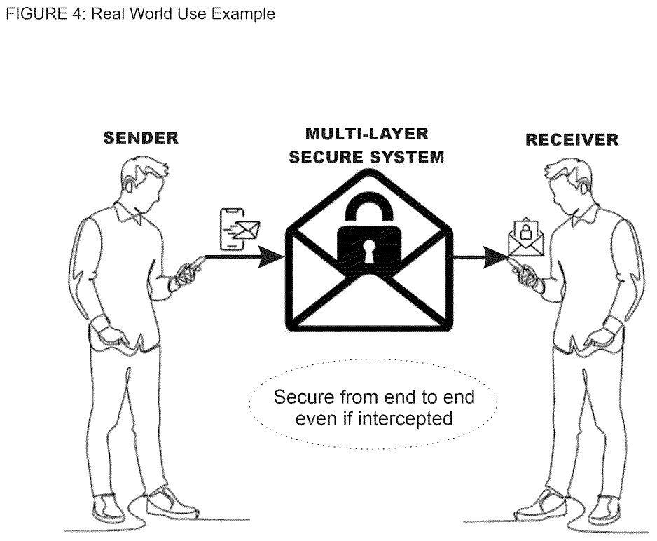

FIG. 5: Application in Simulated Messaging Environment

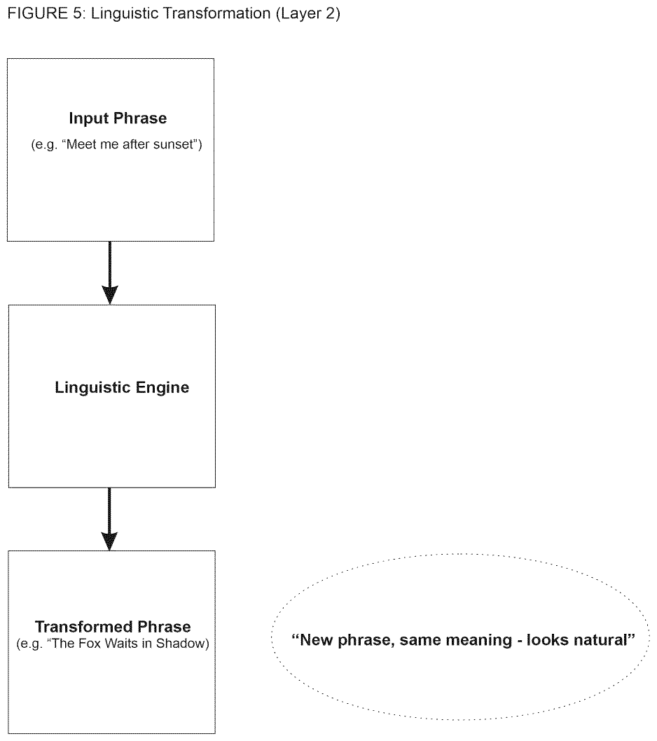

FIG. 6: Secure Deployment Structure with Local Obfuscation Routing

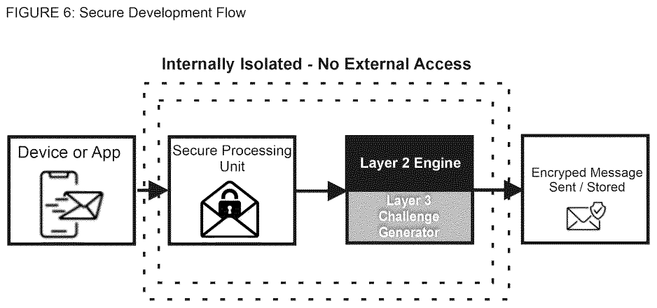

Note to Examiner: Figures are illustrative only. No functional code, mappings, or methodologies are disclosed.

### DETAILED DESCRIPTION OF THE INVENTION

### I. Overview of the Multi-Layer Architecture

All layers are modular and isolated. Each one performs a self-contained logical transformation that is not reversible without internal configuration knowledge. These configurations are:
Privately held
Not derived algorithmically
Not exposed via output data

### II. Layer 1: Initial Transformation (As per Parent Filing)

Already disclosed in original application. Applies first-level non-key-based transformation to digital data using deterministic structure reshaping.

### III. Layer 2: Contextual Obfuscation Transformation

Operates on top of Layer 1
Receives the already transformed data and applies further contextual reshaping
Transformed data takes the form of plain language that carries no semantic trace of the original
Each transformation rule is known only to the system operator

### Example (Illustrative Only):

Input: “I will meet the fox at sunset.”
Transformed Output: “The rabbit dances before twilight.”
(Same meaning. No surface trace.)
No symbolic markers are used or exposed.
Transformation logic is not reusable without internal contextual structure.

### IV. Layer 3: One-time Adaptive Challenge Logic

Activated upon request to access secured data
System generates a time-specific transformation challenge
Output appears as coherent but context-bound information
Only a counterpart trained on the same configuration can resolve access

Every access attempt generates a new, non-repeating challenge, eliminating reuse or predictability.

### V. Layer 3 Deployment: Secure Obfuscation & Isolation

All transformations beyond Layer 1 are executed locally within secure, non-exportable runtime environments.

Components include:
Contextual Transformation Module
Response Validation Mechanism
Interface Router (No external APIs exposed)

System structure ensures data never exits in decrypted or partially transformed states.

Runtime execution is obfuscated and isolated, preventing external mapping or monitoring.

### Use Case Scenarios

Military communications: Secure message transmission without traceable encoding
Secure financial data routing: Eliminates static payload risks
Digital ID authentication: Challenge-response logic replaces password/key-based verification
Enterprise & cloud environments: Each user receives unique access logic per session

1. A contextual transformation system that obfuscates encrypted data into human-readable, non-repeating output formats known only to the system operator.

2. A one-time, dynamic challenge system that generates context-aware output upon each access attempt.

3. A non-symbolic data reshaping mechanism that resists AI pattern recognition and decryption heuristics.

4. A private configuration architecture wherein all transformation logic is isolated within local runtime.

5. A multi-layered encryption model integrating keyless transformation, contextual reshaping, and adaptive access logic.
